(19) United States
(12) Patent Application Publication
(10) Pub. No.: US 2025/0336620 A1
(43) Pub. Date: Oct. 30, 2025

(54) Actuation Knob with Integrated Padlocking Link

(71) Applicant: Eaton Intelligent Power Limited, Dublin 4 (IE)

(72) Inventors: Asad MUJAWAR, Pune (IN); Roger BURKETT, Melton Mowbray (GB); Ryszard Krzysztof BEDNARSKI, Loughborough (GB)

(21) Appl. No.: 18/880,255

(22) PCT Filed: Jul. 13, 2023
(86) PCT No.: PCT/EP2023/025321

§ 371 Date: Dec. 30, 2024

(30) Foreign Application Priority Data
Jul. 19, 2022 (IN) 202211041279
Aug. 31, 2022 (GB) 2212582.7

(51) Int. Cl. H01H 9/28

(52) U.S. Cl. CPC H01H 9/281

(57) ABSTRACT

Some embodiments relate to an actuation knob for use in opening and closing a switch, and a device and system comprising the same. The actuation knob is configured to move with respect to a first axis and includes: an engagement portion configured for engagement by a user, the engagement portion having a slot; and a slidable portion disposed within the slot and configured to slide relative to the engagement portion. The slidable portion is configured to slide between a first position and a second position along a second axis, wherein the first and second axes are non-parallel. The slidable portion comprises at least two compliant mechanisms biased in a direction away from the second axis and offset from one another in a direction perpendicular to the second axis along a plane of the slidable portion.

### CROSS-REFERENCE TO RELATED APPLICATIONS

This application is a national phase filing under 35 C.F.R. § 371 of and claims priority to PCT Patent Application No. PCT/EP2023/025321, filed on Jul. 13, 2023, which claims the priority benefit under 35 U.S.C. § 119 of Indian patent application Ser. No. 20/221,1041279, filed on Jul. 19, 2022, and British Patent Application No. 2212582.7, filed on Aug. 31, 2022, the contents of which are hereby incorporated in their entireties by reference.

### FIELD

This relates to an actuation knob with integrated padlocking link, and a method of operating the same. In particular, the padlocking link is provided by way of a slidable portion disposed within an engagement portion of the actuation knob. A device and system incorporating the actuation knob are also described herein

### BACKGROUND

It is desirable to provide lockable switches or switching modules to prevent unauthorised opening and/or closing of the switch. Switches may be locked in an “off” position during repair or maintenance for safety, or may be locked “on” to stop power supply being disrupted.

Some switches have integrated padlocking links (mechanisms linked to the switch and configured to receive a padlock or other locking means) which can be pulled out to lock the switch. Other switches have an actuation knob with a padlocking link which can be pushed, slid or rotated to access a padlock hole or aperture. In other word, the actuation means is lockable, rather than the switch itself.

Some lockable actuating means use a rotating, lever type padlocking link. These mechanisms require various components, such as pivots/hinges, springs, etc. The multiple parts, and precision assembly process, increases the cost and complexity of the device. Other lockable actuating means use a sliding or slider type padlocking link, but these components can require complex tooling for manufacture.

It is therefore desirable to provide a simple, robust, lockable actuation means with integrated padlocking link, which is cost effective and easy to manufacture.

### SUMMARY

Aspects of the presently disclosed subject matter are set out in the independent claims.

Disclosed herein is an actuation knob for use in opening and closing a switch, wherein the actuation knob is configured to move with respect to a first axis. The actuation knob being configured to move with respect to a first axis comprises: the actuation knob being configured to rotate (substantially) around the first axis; or the actuation knob being configured to slide (substantially) along the first axis. The actuation knob comprises: an engagement portion configured for engagement by a user, the engagement portion having a slot; and a slidable portion disposed within the slot. The slidable portion is configured to slide relative to the engagement portion. The slidable portion is configured to slide between a first position and a second position (substantially) along a second axis, wherein the first and second axes are non-parallel. In other words, regardless of how the actuation knob moves, the slidable portion slides in a different direction to the movement of the actuation knob. The slidable portion comprises at least two compliant mechanisms biased in a direction away from the second axis and offset from one another in a direction perpendicular to the second axis along a plane of the slidable portion. In examples where the actuation knob rotates around the first axis, the least two compliant mechanisms are offset from one another along the first axis. In the first position, the compliant mechanisms are configured to engage with one or more first recesses of the slot to retain the slidable portion in the first position. In the second position, the compliant mechanisms are configured to engage with one or more second recesses of the slot to retain the slidable portion in the second position.

This configuration facilitates provision of a more robust actuation knob with integrated padlocking means. The slidable portion can be formed as a single piece (i.e. the compliant mechanisms are integral to the rest of the slidable portion) and can be easily inserted into the engagement portion without the need for complex assembly or multiple components. By offsetting the compliant mechanisms in the manner described, the actuation knob may be narrower than previous approaches, without compromising on stability. The actuation knob may thus be smaller, and cheaper to manufacture, as well as more ergonomic for a user.

In some examples, the slidable portion further comprises an aperture configured to receive locking means therethrough when the slidable portion is in the first position. The aperture is arranged such that said locking means prevent the slidable portion from sliding to the second position. In this way, the actuation knob may be locked in an “off” (or “on”) position. This can allow for routine maintenance and inspection (or prevent unintended interruption of a power supply to a load). Safety may therefore be improved. In some examples, the aperture is at least partly disposed within the slot of the engagement portion when the slidable portion is in the second position. This can prevent locking of the actuation knob in the second position, e.g. stopping the actuation knob accidentally being locked in the wrong position. Moreover, the arrangement described herein can be easier to use as compared to padlocking links which need to be rotated or depressed by a user, and can facilitate locking of the actuation knob one-handed.

In some implementations, the at least two compliant mechanisms comprise a first compliant mechanism biased in a first direction away from the second axis and a second compliant mechanism biased in a second direction away from the second axis. The first and second directions are different. This can improve stability through the provision of different biasing against the engagement portion. In some examples, the first and second directions extend either side of the second axis. This can further improve stability of the slidable portion within the slot. In some specific examples, the first and second directions extend at (substantially) equal but opposite angles from the second axis. This can assist the user in pushing the slidable portion between the first and second positions, by needing only one input of force to overcome the biasing of the compliant mechanisms before the slidable portion begins to move.

In some examples, the compliant mechanisms comprise protrusions configured to engage with the one or more first and one or more second recesses. This can improve retention of the slidable portion in the first/second mechanisms. Optionally, the protrusions each comprise an apex and a symmetrical portion disposed around the apex. This can improve the bi-directional sliding of the slidable portion, and ensure that the user can apply a same amount of force regardless of a direction in which the slidable portion is being pushed.

Also described herein is a device for use with a switching module, the device comprising: a housing configured to couple to the switching module; an actuation knob as described herein. The actuation knob is configured to move with respect to the first axis relative to the housing to open and close a switch within the switching module.

In some specific examples, the actuation knob is configured to rotate relative to the first axis relative to the housing to open and close the switch. In the first position, the slidable portion is configured to engage the housing to prevent rotation of the actuation knob. In the second position, the actuation knob is configured to rotate around the first axis in response to actuation by the user. In other words, the position of the slidable portion along the second axis determines whether or not the actuation knob can move with respect to the first axis.

In some examples, the slidable portion further comprises a guide portion configured to protrude through the slot, the guide portion configured to engage with the housing in the first position to prevent rotation of the actuation knob. By engaging the slidable portion with the housing, a stronger and more robust device may be provided.

In some specific examples, the housing further comprises an engagement channel configured to receive the guide portion, the engagement channel configured to allow the slidable portion to slide between the second position and the first position. Optionally, the housing further comprises a guide channel configured to receive the guide portion, the guide channel controlling an extent of rotation of the actuation knob. In this way, movement of the actuation knob can be controlled by way of the housing design, facilitating devices with quarter turn, half turn, or full turn knobs for example. Safety may therefore be improved by preventing undesired or unintended movement of the actuation knob.

In some examples, the device further comprises an actuating mechanism disposed within the housing. The actuation knob is configured to engage with the actuating mechanism to (directly or indirectly) open and close the switch within the switching module.

Also described herein is a system comprising: a switching module comprising a switch configured to open and close an electrical circuit arranged through the switching module; and a device as described herein.

In some examples, the system further comprises one or more further switching modules, each comprising a switch. The housing is configured to couple to and connect each of the switching modules, wherein the actuation knob is configured to rotate relative to the housing to open and close each of the switches simultaneously.

Also described herein is a method for operating an actuation knob. The method comprises moving, when the slidable portion is in the second position and the compliant mechanisms are engaged with the one or more second recesses, the actuation knob with respect to the first axis from a third position to a fourth position. In some examples, in the third position the switch is closed and the switching module defines a current conduction path and in the fourth position the switch is open and no current conduction path is defined. In other examples, the opposite arrangement is provided. When the actuation knob is in the fourth position, sliding the slidable portion along the second axis from the second position to the first position to engage the compliant mechanisms with the one or more first recesses. Optionally, the method further comprises, when the slidable portion is in the first position, inserting locking means through an aperture in the slidable portion to prevent the slidable portion from sliding to the second position. In this way the actuation knob may be locked “off”, or “on”, as appropriate.

Also described herein is an actuation knob for use in opening and closing a switch, wherein the actuation knob is configured to rotate around a first axis and comprises: an engagement portion configured for engagement by a user, the engagement portion having a slot, and a slidable portion disposed within the slot and configured to slide relative to the engagement portion, the slidable portion configured to slide between a first position and a second position along a second axis, wherein the first and second axes are non-parallel. The slidable portion comprises at least two compliant mechanisms biased in a direction away from the second axis and offset from one another along the first axis. In the first position the compliant mechanisms are configured to engage with one or more first recesses of the slot to retain the slidable portion in the first position. In the second position the compliant mechanisms are configured to engage with one or more second recesses of the slot to retain the slidable portion in the second position. Optionally, the slidable portion further comprises an aperture configured to receive locking means therethrough when the slidable portion is in the first position, the aperture arranged such that said locking means prevent the slidable portion from sliding to the second position.

Also disclosed herein is a device for use with a switching module, the device comprising: a housing configured to couple to the switching module; and an actuation knob configured to rotate around a first axis relative to the housing to open and close a switch within the switching module. The actuation knob comprises: an engagement portion configured for engagement by a user, the engagement portion having a slot, and a slidable portion disposed within the slot and configured to slide relative to the engagement portion, the slidable portion configured to slide between a first position and a second position along a second axis, wherein the first and second axes are non-parallel, wherein the slidable portion comprises at least two compliant mechanisms biased in a direction away from the second axis and offset from one another along the first axis; wherein in the first position the slidable portion is configured to engage the housing to prevent rotation of the actuation knob, and the compliant mechanisms are configured to engage with one or more first recesses of the slot to retain the slidable portion in the first direction; and wherein in the second position the actuation knob is configured to rotate around the first axis in response to actuation by the user and the compliant mechanisms are configured to engage with one or more second recesses of the slot to retain the slidable portion in the second position. Optionally, the slidable portion further comprises an aperture configured to receive locking means therethrough when the slidable portion is in the first position, the aperture arranged such that said locking means prevent the slidable portion from sliding to the second position.

### LIST OF FIGURES

FIG. 1: FIG. 1 shows an exploded perspective view of an example actuation knob;

FIG. 2: FIG. 2 shows a plan and bottom view of the actuation knob of FIG. 1 in a first position (FIG. 2A), a second position (FIG. 2B) and an end position (FIG. 2C);

FIG. 3: FIG. 3A shows a perspective view of a slidable portion of the actuation knob of FIG. 1, and FIG. 3B shows a perspective view of an engagement portion of the actuation knob, showing the slot in which the slidable portion is disposed;

FIG. 4: FIG. 4A shows a side view of the actuation knob of FIG. 1 rotatably coupled to a housing, and FIG. 4B shows a cross section of the actuation knob, when the slidable portion is in the second position;

FIG. 5: FIG. 5A, 5B show the same arrangement as FIGS. 4A, 4B when the slidable portion is in the first position;

FIG. 6: FIG. 6 shows a perspective view of the housing of FIGS. 4 and 5;

FIG. 7: FIG. 7 shows a perspective view of a system comprising the device of FIGS. 4 and 5 coupled to a switching module.

### DETAILED DESCRIPTION

Described herein is a lockable actuating means with an integrated padlocking link. The lockable actuation means is provided in the form of an actuation knob for use in opening and closing a switch, with the integrated padlocking link provided by a slidable portion.

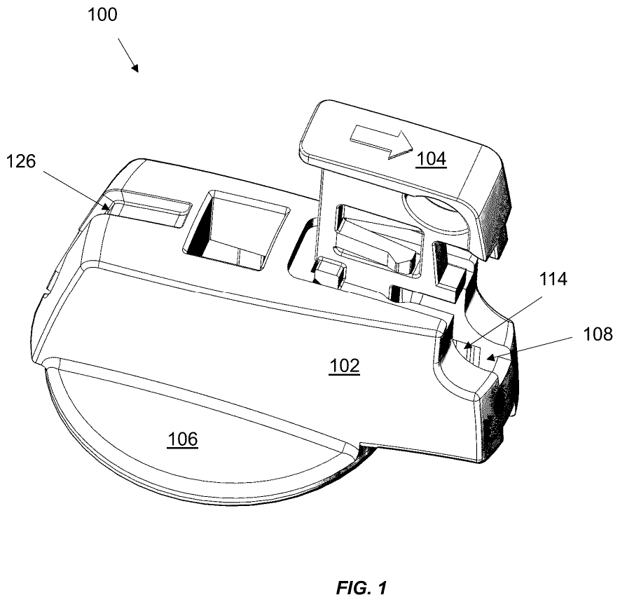

The actuation knob for use in opening and closing a switch is described with reference to FIG. 1. In particular, FIG. 1 shows an exploded view of an example actuation knob 100 comprising an engagement portion 102 configured for engagement by a user, and a slidable portion 104. The actuation knob 100 further comprises a base portion 106. The engagement portion protrudes from the base portion. A slot 108 is formed within the engagement portion 102. The slidable portion 104 is disposed within the slot 108 and is configured to slide relative to the engagement portion.

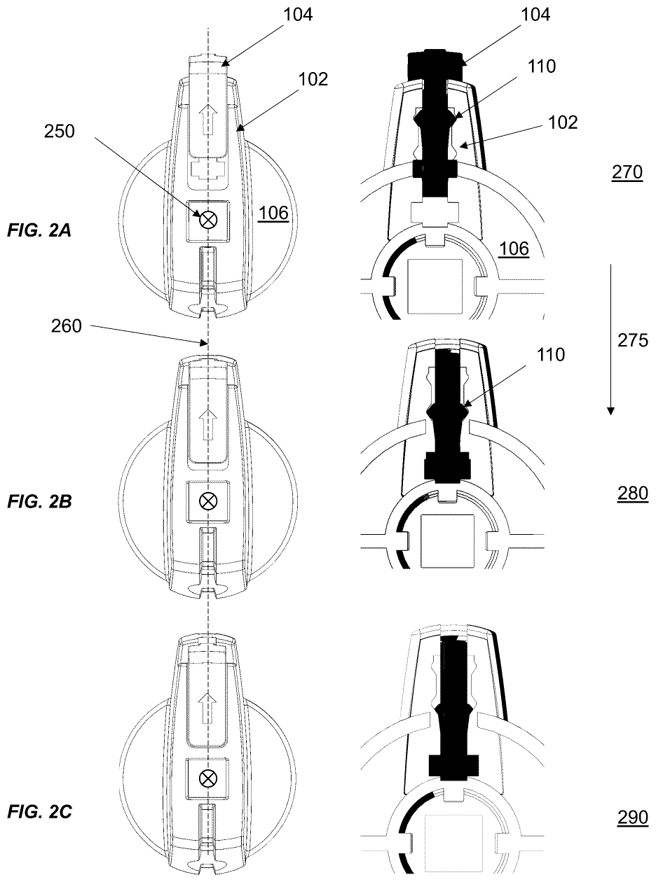

With reference to FIG. 2, movement of the slidable portion 104 relative to the engagement portion 102 is discussed in more detail. The actuation knob is configured to move with respect to a first axis. In some examples, the actuation knob is configured to slide along the first axis. In other examples, the actuation knob is configured to rotate around the first axis. It will be understood that examples describing or showing rotation of the actuation knob are just one implementation, and that such replacing can be replaced with a sliding motion/movement of the actuation knob. Sliding of the actuation knob can be implemented without any modification of the features of the engagement portion 102 or slidable portion 104 described herein.

In the following discussion, the actuation knob is described as rotating around a first axis 250 (here shown extending into the page). In this example, the first axis 250 is at the centre of the base portion 106, but any other location for the rotation axis may be used, depending on the particular geometry of the application. The slidable portion 104 is configured to slide along a second axis 260. In this example the second axis is perpendicular, or substantially perpendicular to the first axis. However, this is an example only. Any first and second axes may be used, provided said first and second axes are non-parallel. For example, when the actuation knob is configured to slide rather than rotate, the actuation knob may be configured to slide laterally along the first axis and the slidable portion can slide in a transverse direction along the second, non-parallel axis.

In particular, the slidable portion 104 is configured to slide between a first position 270 shown in FIG. 2A and a second position 280 shown in FIG. 2B. The sliding is in direction 275 along the second axis 260. Intermediate positions between these first and second positions are not shown. FIG. 2C shows an end position 290 of the slidable portion when sliding in direction 275. In other words, slidable portion 104 cannot slide beyond position 290 due to the dimensions of the slot 108 and engagement portion 102. To move from the second position 280 to the first position 270, slidable portion 104 slides along the second axis 260 in a direction opposite direction 275. The left hand figure of each of FIGS. 2A-2C shows a top view of the actuation knob 100, and the right hand figure shows a bottom or underneath view of the actuation knob (i.e. the actuation knob 100 is seen from a direction not visible in normal use).

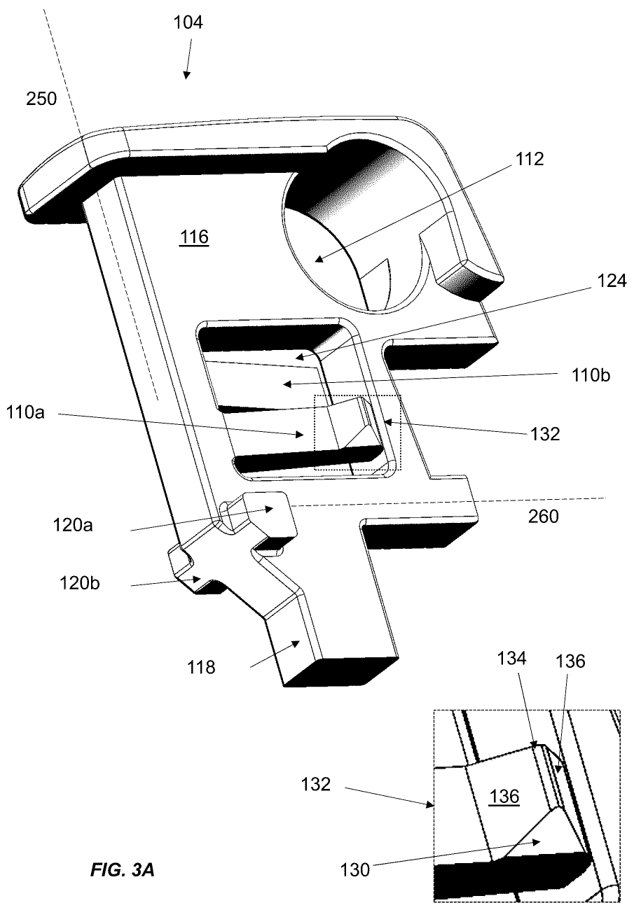

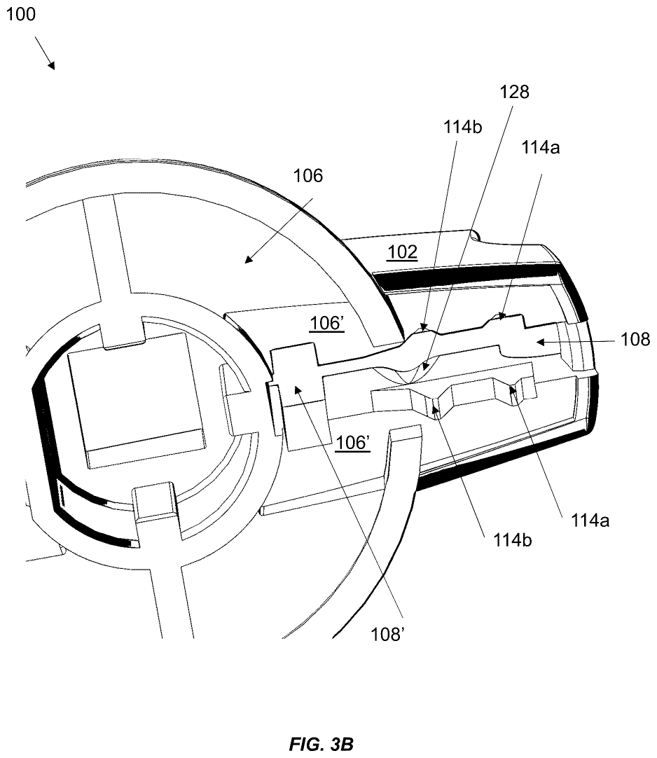

FIG. 3A illustrates an example implementation of the slidable portion 104, and FIG. 3B shows an example implementation of the actuation knob 100 (without the slidable portion 104). The actuation knob 100 is here shown from underneath (i.e. from a direction not visible in normal use) in order to better illustrate the slot 108. In this example, slot 108 extends through the base portion 106 to form a through-hole in the engagement portion, but in some other examples the slot may not extend fully through the base portion and/or engagement portion.

The slidable portion comprises at least two compliant mechanisms 110. The compliant mechanisms are biased away from a main body 116 of the slidable portion. In other words, the compliant mechanisms 110 extend away from the main body of the slidable portion and when compressed are configured to exert a biasing force in a direction away from the main body 116. In other words, the compliant mechanisms 110 are biased in a direction away from the second axis (orientation represented here by dashed line 260). The compliant mechanisms may be partially disposed within the main body 116 of the slidable portion; for example, the compliant mechanisms can be partially provided within a recess or aperture formed within the main body 116, such as opening 124.

In the particular implementation of FIG. 3A, the at least two compliant mechanisms comprise a first compliant mechanism 110a and a second compliant mechanism 110b (collectively, compliant mechanisms 110). The first compliant mechanisms 110a is biased in a first direction away from the second axis 260 and the second compliant mechanism 110b is biased in a second direction away from the second axis 260. In some examples, the first and second directions are the same: e.g. the compliant mechanisms can be disposed one above the other along the first axis and extend along a same direction away from the main body 116 of the slidable portion. In other examples, the first and second directions are different. The first and second directions can extend from a same side of the main body 116 of the slidable portion, or the first and second directions can extend from opposite sides of the main body 116 of the slidable portion.

In the example illustrated in FIG. 3A the first and second directions are different, and the first and second directions extend either side of the second axis 260. In particular, the first and second directions extend at equal but opposite angles from the second axis 260. In other words, when viewed from above/below (as in FIG. 2), the slidable portion 104 appears symmetrical. This can improve the stability of the slidable portion during sliding, and improve retention of the slidable portion within the slot.

The compliant mechanisms 110 are configured to engage with recesses 114 of slot 108 to retain the slidable portion 104 in set positions within the slot 108. In particular, slot 108 comprises one or more first recesses 114a and one or more second recesses 114b (collectively, recesses 114). In this example, there are two first recesses 114a, one either side of slot 108. In this example, there are two second recesses 114b, one either side of slot 108. However, any other arrangement of recesses 114 may be provided, depending on the geometry of the compliant mechanisms and the desired set positions.

When the slidable portion is in the first position 270 of FIG. 2A, the compliant mechanisms 110 are configured to engage with the one or more first recesses 114a of the slot 108 to retain the slidable portion in the first position 270. When the slidable portion is in the second position 280 of FIG. 2B, the compliant mechanisms 110 are configured to engage with the one or second first recesses 114b of the slot 108 to retain the slidable portion in the second position 280. To move the slidable portion between the first and second positions requires input of force to overcome the biasing of the compliant mechanisms 110. Similarly, to move the slidable portion 104 from the second position 280 to the end position 290 requires input of force to overcome the biasing of the compliant mechanisms (it can be seen from FIG. 2 that the compliant mechanisms 110 are compressed in position 290 as compared to position 280). This force can be provided by user actuation of the slidable portion 104 along the second axis 260. In the absence of such force, the slidable portion is retained in the first or second position by the biasing of the compliant mechanisms.

As can be seen from FIG. 3A, the compliant mechanisms 110 are offset from one another along the first axis (orientation represented with dashed line 250). By offsetting the compliant mechanisms 110 along the first axis 250, the compliant mechanisms may be disposed closer together. In examples where the actuation knob slides along the first axis, the compliant mechanisms are offset from one another in a direction perpendicular to the second axis along a plane of the slidable portion. The planar surface of the main body 116 is the plane defined by the first axis 250 and second axis 260 as illustrated in FIG. 3A. In some specific examples, where the actuation knob slides along a first axis which is perpendicular to the second axis, the compliant mechanisms are offset from one another in a third direction (not shown) which is perpendicular to both the first axis and the second axis. Offsetting the compliant mechanisms can facilitate provision of a narrower slidable portion, and thus a smaller and more ergonomic actuation knob. This benefit is further improved when the compliant mechanisms are partially provided within a recess or aperture formed within the main body 116, such as opening 124.

The compliant mechanisms 110 may in some implementations not shown here, at least partially overlap. In some examples, the compliant mechanisms may almost completely overlap or meet in the middle of the slidable portion 104. The degree of overlap can be determined by a desired width of the slidable portion, which can itself be predetermined based on a given padlocking link strength and/or intended operation or use of the actuation knob. Overlapping the compliant mechanisms (e.g. along the first axis, or along a plane of the slidable portion) can therefore further facilitate provision of a narrower slidable portion. The slidable portion can thus be more compact and have a smaller form factor. The actuation knob may thus be more ergonomic for a user.

Moreover, the arrangement described herein can be manufactured without the need for complex tooling or assembly. For example, simple core and cavity tooling can be used to form the slidable portion 104.

The compliant mechanisms 110 comprise protrusions 132, illustrated in more detail in the dashed box of FIG. 3A. The protrusions 132 are configured to engage with the one or more first 114a and one or more second 114b recesses. In this example, the protrusions 132 each comprise an apex 134 and a symmetrical portion disposed around the apex. The symmetrical portion is comprises of two fillets 136, extending either side of the apex 134. This arrangement facilitates the bi-directional sliding along the second axis, as well as the retention of the slidable portion in a plurality of set positions.

The slidable portion 104 further comprises an aperture 112. The aperture is configured to receive locking means (not shown), such as a padlock or other lock. In other words, the locking means can be inserted through the aperture 112 and then fastened/locked. Any other shape and/or positioning of the aperture 112 may also be used, as required by the particular application. When locking means are inserted through the aperture 112, the slidable portion 104 is prevented from sliding from towards the second position 280 and is instead retained in the first position 270. In other words, the aperture 112 is arranged such that said locking means prevent the slidable portion 104 from sliding to the second position. This arrangement can allow the actuation knob to be locked “off” with one or more padlocks or locking means, improving safety during routine testing or maintenance. In some examples, the aperture 112 is at least partly disposed within the slot of the engagement portion 102 when the slidable portion 104 is in the second position 280. This can prevent the actuation knob from being accidentally locked in an “on” position. Moreover, since the slidable portion 104 can be formed as an integral piece, the component may be stronger when locked than previous approaches which rely on movable levers or pivots.

The slidable portion 104 further comprises a guide portion 118. The guide portion here extends from the main body 116, but any other arrangement can be provided. The guide portion 118 is configured to protrude through the slot 108 at region 108′. The guide portion acts as an additional stop mechanism, preventing the slidable portion from moving beyond position 290 along direction 275. The slidable portion 104 in this example also comprises side protrusions 120a, 120b (collectively side protrusions 120). The side protrusions 120 are also configured to protrude through the slot 108 at region 108′. These side protrusions contact an underside surface of the base portion 106 (i.e. the surface 106′ seen in FIG. 3B) and act to guide the slidable portion 104 as it slides along the second axis. This can improve stability of the slidable portion. The side protrusions can also act as an additional stop mechanism, contacting an edge of the base portion 106 and preventing the slidable portion from moving past the first position 270. This can improve stability of the slidable portion, and minimise damage to the slidable portion during use.

The slidable portion 104 can be inserted into the slot 108 during assembly of the actuation knob. The geometry of the slidable portion is such that the slidable portion snaps into the slot. In other words, the engagement portion 102 and the slidable portion 104 can be coupled by way of a snap fit. Fillets 130 on the protrusions 132 of the compliant mechanisms 110 engage with grooves 128 within the slot 108 of the engagement portion 102 act to compress the compliant mechanisms when the slidable portion is pushed from the exploded arrangement of FIG. 1 in a direction along the first axis. The compliant means are biased such that they snap into the second recesses 114b once the slidable portion is fully inserted. A fastening means (not shown) may then be inserted at region 126 of FIG. 1. Due to the arrangement of the slidable portion, that component cannot be removed without first removing the fastening means, preventing unauthorised removal of any locking means inserted through aperture 112. A more reliable actuation means may therefore be provided. Safety may also be improved.

Operation of the actuation knob 100 will now be discussed. Operation of the knob comprises moving, when the slidable portion 104 is in the second position 280 and the compliant mechanisms 110 are engaged with the one or more second recesses 114b, the actuation knob with respect to the first axis from a third position to a fourth position. Optionally, this moving operation comprises rotating, when the slidable portion 104 is in the second position 280 and the compliant mechanisms 110 are engaged with the one or more second recesses 114b, the actuation knob around the first axis 250 from a third position to a fourth position. In other implementations, this moving operation comprises sliding the actuation knob along the first axis. Operation of the knob further comprises, when the actuation knob is in the fourth position, sliding the slidable portion 104 along the second axis 260 from the second position to the first position 270 to engage the compliant mechanisms 110 with the one or more first recesses 114a.

The operation can further comprise, when the slidable portion is in the first position 270, inserting locking means through the aperture 112 in the slidable portion to prevent the slidable portion from sliding to the second position. In this way, the actuation knob may be locked. In some examples, when the actuation knob is in the third position the switch is closed and a current conduction path is defined through the switch. When the actuation knob is in the fourth position, the switch is open and no current conduction path is defined. Therefore, the actuation knob can be locked in the “off” position, when the switch is open. This can facilitate safer maintenance and inspection of the switch. However, it may be preferable to lock the actuation knob in the “on” position instead, for example to prevent interruption of power supply to a load. In these cases, the third and fourth positions can instead correspond to open and closed positions of the switch, respectively. In some implementations, the actuation knob can be configured such that the slidable portion can slide to the first position 270 in both the third and fourth rotational positions of the actuation knob 100.

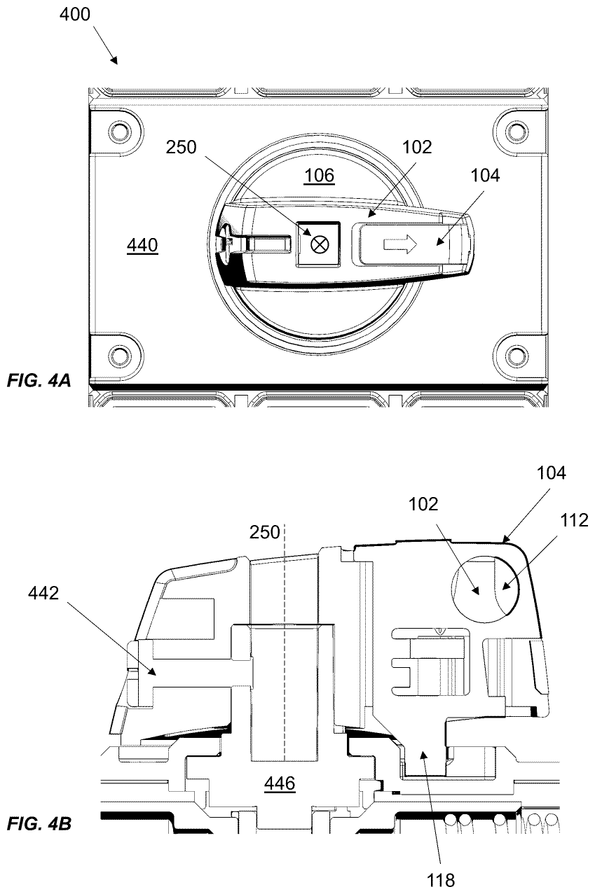

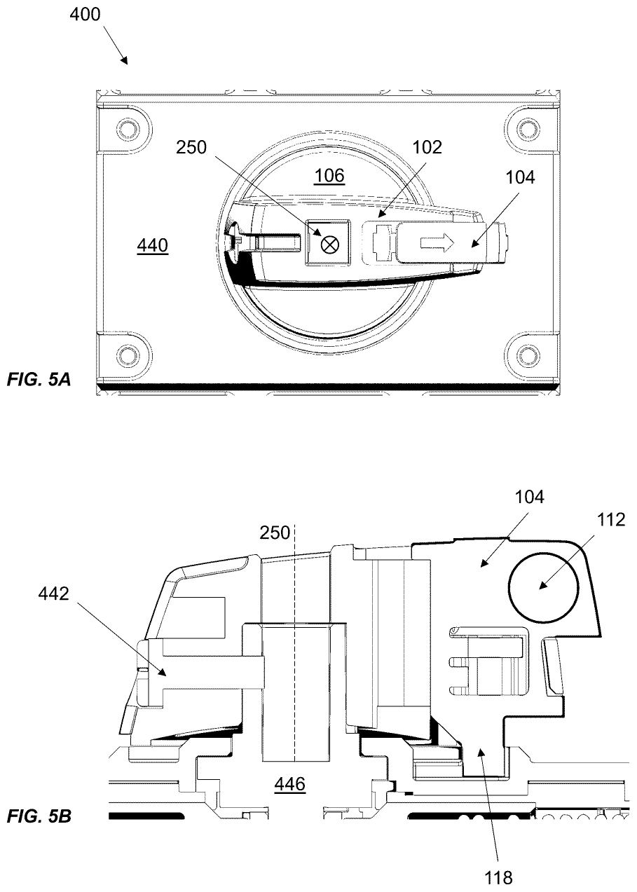

With reference to FIG. 4 and FIG. 5, a device 400 for use with a switching module is described. The device comprises a housing 440 configured to couple to a switching module. The device further comprises the actuation knob 100 discussed above. The actuation knob is configured to move with respect to the first axis relative to the housing to open and close a switch within the switching module. In some examples, the actuation knob can slide along the first axis (and is slidably coupled to the housing). In other examples, the actuation knob can rotate around the first axis (and is rotatably coupled to the housing). In the following description, the actuation knob is described as being configured to rotate around the first axis 250 (here defined into the page) relative to the housing 440 to open and close the switch within the switching module.

A fastening means 442 is inserted at region 126 of the actuation knob to couple the actuation knob 100 to the housing 440. An actuating mechanism 446 is disposed within the housing 440. The actuating mechanism 446 can be coupled, either directly or indirectly, to a switch. The actuation knob 100 is configured to engage with the actuating mechanism 446 such that rotation of the actuation knob causes the switch to open or close. In some examples, the actuating mechanism 446 is simply a linkage or shaft, configured to transfer rotation of the knob 100 to a switching mechanism controlling the switch.

FIGS. 4A and 4B illustrate the device 400 when the slidable portion 104 is in the second position 280. The actuation knob is in the fourth position. The aperture 112 is at least partially disposed within the engagement portion 102 (visible through aperture 112 in FIG. 4B). In this second position, the actuation knob is configured to rotate around the first axis 250 in response to actuation by a user to cause opening and closing of the switch.

FIGS. 5A and 5B illustrate the device 400 when the slidable portion 104 is in the first position 270. The actuation knob is in the fourth position. The aperture 112 is not disposed within the engagement portion 102, but is configured to receive a locking means therethrough. In this first position, the slidable portion 104 is configured to engage the housing to prevent rotation of the actuation knob 100 relative to the housing 440. In this way, closing (or opening) of the switch is prevented whilst the slidable portion 104 is in the first position.

Engagement of the slidable portion 104 with the housing can be provided by the guide portion 118 protruding through the slot 118. In particular, the guide portion can be configured to engage with the housing 440 when the slidable portion is in the first position to prevent rotation of the actuation knob 100. The guide portion 118 can also be configured such that, in the second position, the actuation knob 100 is configured to rotate around the first axis 250 in response to actuation by a user to cause opening and closing of the switch. However, any other form of engagement between the slidable portion 104 and the housing 440 is possible.

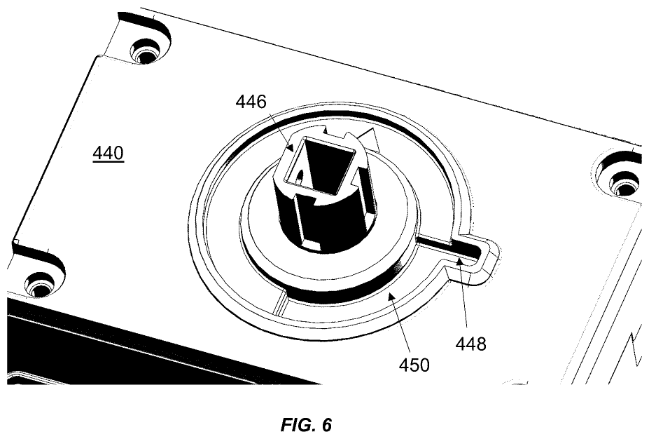

In some particular examples, illustrated in FIG. 6, the housing 440 comprises an engagement channel 448 configured to receive the guide portion 118. The engagement channel is configured to allow the slidable portion to slide between the second position and the first position. When the slidable portion is in the first position, the engagement channel is configured to prevent rotation of the actuation knob 100. Moreover, by revealing the aperture 112 (or allowing access to the aperture 112 by a user) in the first position, the actuation knob 100 can be locked with one or more padlocks or locking means (locking the switch “off”, or “on”, as appropriate to the application).

In some further examples, the housing further comprises a guide channel 450 configured to receive the guide portion 118 when the slidable portion 104 is in the second position. The guide channel 450 controls an extent of rotation of the actuation knob 110 around the first axis 250 (or a degree of sliding of the actuation knob 110 along the first axis). In the example of FIG. 6, the guide channel 450 allows a quarter turn of the actuation knob 100 from the fourth position to the above-described third position, but any suitable size/shape of guide channel may be provided. Similarly, engagement channels may be provided in other positions around the guide channel such that the actuation knob may be locked both “off” and “on”, as required. The guide channel 450 and engagement channel 448 are integrally formed to facilitate reception and movement of the guide portion 118. In this example the extension channel 448 extends in a direction normal to an edge of the guide channel 450, though other arrangements are possible as required by the respective arrangements of the non-parallel first and second axes.

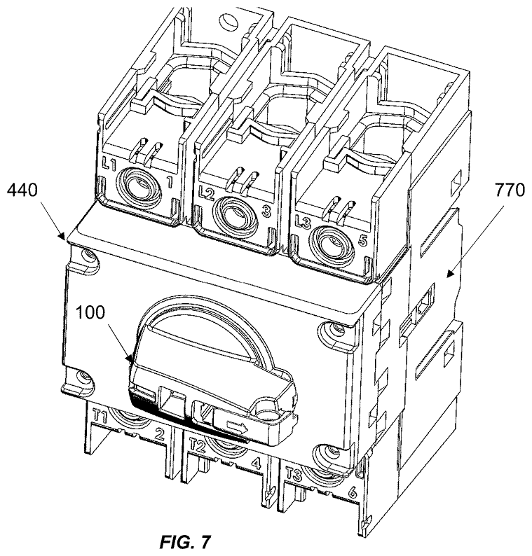

With reference to FIG. 7, a system 700 is described. The system comprises the device 400 described with reference to FIGS. 4-6 and a switching module 770. The switching module comprises a switch configured to open and close an electrical circuit arranged through the switching module 770.

In some examples, the actuation knob 100 may be coupled to the switching module 770 itself, without the intermediary housing 440. In other examples, the system further comprises one or more further switching modules (not shown), each comprising a switch. The housing 440 is configured to connect each of the switching modules, wherein a single actuation knob 100 is configured to rotate relative to the housing 440 to cause opening and/or closing of each of the switches simultaneously.

Examples described herein may be combined wherever suitable.

1. An actuation knob for use in opening and closing a switch, wherein the actuation knob is configured to move with respect to a first axis and comprises:
an engagement portion configured for engagement by a user, the engagement portion having a slot; and
a slidable portion disposed within the slot and configured to slide relative to the engagement portion, the slidable portion configured to slide between a first position and a second position along a second axis, wherein the first and second axes are non-parallel;
wherein the slidable portion comprises at least two compliant mechanisms biased in a direction away from the second axis and offset from one another in a direction perpendicular to the second axis along a plane of the slidable portion,
wherein in the first position the compliant mechanisms are configured to engage with one or more first recesses of the slot to retain the slidable portion in the first position, and
wherein in the second position the compliant mechanisms are configured to engage with one or more second recesses of the slot to retain the slidable portion in the second position.

2. The actuation knob of claim 1, wherein the slidable portion further comprises an aperture configured to receive locking means therethrough when the slidable portion is in the first position, the aperture arranged such that said locking means prevent the slidable portion from sliding to the second position.

3. The actuation knob of claim 2, wherein the aperture is at least partly disposed within the slot of the engagement portion when the slidable portion is in the second position.

4. The actuation knob of claim 1, wherein the at least two compliant mechanisms comprise a first compliant mechanism biased in a first direction away from the second axis and a second compliant mechanism biased in a second direction away from the second axis, wherein the first and second directions are different.

5. The actuation knob of claim 4, wherein the first and second directions extend either side of the second axis.

6. The actuation knob of claim 5, wherein the first and second directions extend at equal but opposite angles from the second axis.

7. The actuation knob of claim 1, wherein the compliant mechanisms comprise protrusions configured to engage with the one or more first and one or more second recesses, the protrusions each comprising an apex and a symmetrical portion disposed around the apex.

8. A device for use with a switching module, the device comprising:
a housing configured to couple to the switching module; and
the actuation knob of any preceding claim, the actuation knob configured to rotate around the first axis relative to the housing to open and close a switch within the switching module, wherein:
in the first position the slidable portion is configured to engage the housing to prevent rotation of the actuation knob, and
in the second position the actuation knob is configured to rotate around the first axis in response to actuation by the user.

9. The device of claim 8, wherein the slidable portion further comprises a guide portion configured to protrude through the slot, the guide portion configured to engage with the housing in the first position to prevent rotation of the actuation knob.

10. The device of claim 9, the housing further comprising an engagement channel configured to receive the guide portion, the engagement channel configured to allow the slidable portion to slide between the second position and the first position.

11. The device of claim 9, the housing further comprising a guide channel configured to receive the guide portion, the guide channel controlling an extent of rotation of the actuation knob.

12. The device of claim 8, further comprising an actuating mechanism disposed within the housing, wherein the actuation knob is configured to engage with the actuating mechanism to open and close the switch within the switching module.

13. A system comprising:
a switching module comprising a switch configured to open and close an electrical circuit arranged through the switching module; and
the device of claim 8.

14. The system of claim 13, further comprising one or more further switching modules, each comprising a switch, the housing configured to connect each of the switching modules, wherein the actuation knob is configured to rotate relative to the housing to open and close each of the switches simultaneously.

15. A method for operating the actuation knob of claim 1, the method comprising:
moving, when the slidable portion is in the second position and the compliant mechanisms are engaged with the one or more second recesses, the actuation knob with respect to the first axis from a third position to a fourth position;
when the actuation knob is in the fourth position, sliding the slidable portion along the second axis from the second position to the first position to engage the compliant mechanisms with the one or more first recesses.
